(19) United States
(12) Patent Application Publication
(10) Pub. No.: US 2023/0361799 A1
(43) Pub. Date: Nov. 9, 2023

(54) MOBILE PHONE PROTECTION CASE

(71) Applicant: Bingqu Xie, Pingyang (CN)

(72) Inventor: Bingqu Xie, Pingyang (CN)

(21) Appl. No.: 18/350,781

(22) Filed: Jul. 12, 2023

(30) Foreign Application Priority Data
Jun. 28, 2023 (CN) 202321657915.0

(51) Int. Cl. H04B 1/3888

(52) U.S. Cl. CPC H04B 1/3888

(57) ABSTRACT

The present disclosure provides a mobile phone protection case, including a case body; a fixed portion is arranged at one end of the case body; the fixed portion is provided with an accommodating slot matched with an edge of a mobile phone; the fixed portion is connected to the case body through an elastic arm; one end of the elastic arm is fixed on the case body, and the other end is fixed on the fixed portion; the elastic arm is in an arc design and abuts against the fixed portion; a fixing slot is formed in the accommodating slot; and a magnetic element is arranged in the fixing slot. A new fixing structure for a mobile phone case and a mobile phone is provided.

### TECHNICAL FIELD

The present disclosure relates to the field of mobile phone accessories, and more particularly, to a mobile phone protection case.

### BACKGROUND

Mobile phones have been widely used. There are also various types of mobile phone protection cases in the market. In the prior art, most mobile phone protection cases are formed by integrally molding silica gel or a plastic material. When in use, the mobile phone protection case sleeves a back cover of a mobile phone. This kind of mobile phone protection case has a single function to only protect the back cover of the mobile phone. If a case body is relatively hard, it is inconvenient to remove the case from the mobile phone. However, a soft silica gel case cannot be provided with a mobile phone holder. Furthermore, there are few protection covers for foldable phones in the market.

### SUMMARY

The technical problem to be solved in the present disclosure is to overcome the shortcomings in the prior art and optimize the prior art. A mobile phone protection case is provided to solve the above problems.

In order to solve the above technical problems, the present disclosure provides the following technical solutions:

The present disclosure provides a mobile phone protection case, including a case body; a fixed portion is arranged at one end of the case body; the fixed portion is provided with an accommodating slot matched with an edge of a mobile phone; the fixed portion is connected to the case body through an elastic arm; one end of the elastic arm is fixed on the case body, and the other end is fixed on the fixed portion; the elastic arm is in an arc design and abuts against the fixed portion; fixing slots are formed in the accommodating slot; and magnetic elements are arranged in the fixing slots.

As a preferred solution of the present disclosure, a pen case is arranged on the other side, corresponding to the accommodating slot, of the fixed portion; and the pen case is provided with a stylus accommodating portion.

As a preferred solution of the present disclosure, the pen case is detachably fixed on the fixed portion.

As a preferred solution of the present disclosure, the fixed portion is provided with a sliding clamping slot; the sliding clamping slot includes an inlet slot and a clamping slot; the pen case is provided with a sliding column; one end of the sliding column is a flange; and the flange enters the sliding clamping slot through the inlet slot, and is fixed in the clamping slot after moving.

As a preferred solution of the present disclosure, a holder device is arranged on a rear side of the case body; the holder device includes a holder accommodating slot and a holder body; a rotating hole is formed in a top side surface of the holder body; a rotating column corresponding to the rotating hole is arranged in the holder accommodating slot; and the rotating column extends into the rotating hole.

As a preferred solution of the present disclosure, a fixing hole is formed in the elastic arm; a threaded hole is formed in the accommodating slot; and a stud is fixed with the threaded hole through the fixing hole.

As a preferred solution of the present disclosure, the elastic arm is made of a TPU material; the case body includes a bottom case and an outer case body; a fixed end of the elastic arm to the fixed portion is provided with a patch portion; and the patch portion is arranged between the bottom case and the outer case body and is bonded by a hot melt adhesive technology.

As a preferred solution of the present disclosure, the patch portion is provided with a positioning hole; a positioning column is arranged on the bottom case; and the positioning column is arranged in the positioning hole.

As a preferred solution of the present disclosure, there are three groups of the elastic arms.

As a preferred solution of the present disclosure, there are two groups of the fixing slots and magnetic elements.

The present disclosure has the beneficial effects: Compared with the prior art, the present disclosure provides a new fixing structure for a mobile phone case and a mobile phone. A fixing effect is achieved jointly by one end of the case body and the magnetic element. Due to the design of the elastic arm, the mobile phone can be fixed through the elasticity. Under a force, the fixed portion can be driven to move, which facilitates removing the mobile phone case from the mobile phone. A group of detachable pen case connection structure and mobile phone holder structure is further added, which is easy to mount and remove. At the same time, the mobile phone protection case can be applied to a foldable phone.

### BRIEF DESCRIPTION OF THE DRAWINGS

In order to describe the technical solutions in the embodiments of the present disclosure more clearly, accompanying drawings required to be used in the descriptions of the embodiments will be briefly introduced below. Obviously, the drawings in the illustration below are merely some embodiments of the present disclosure. Those ordinarily skilled in the art also can acquire other drawings according to the provided drawings without doing creative work. In the drawings:

FIG. 1 is a schematic structural diagram I of the present disclosure;

FIG. 2 is a schematic diagram I of assemblies of the present disclosure;

FIG. 3 is a schematic diagram II of assemblies of the present disclosure;

FIG. 4 is a schematic diagram III of assemblies of the present disclosure;

FIG. 5 is a schematic diagram IV of assemblies of the present disclosure;

FIG. 6 is a schematic diagram V of assemblies of the present disclosure;

FIG. 7 is a schematic diagram VI of assemblies of the present disclosure;

FIG. 8 is a schematic diagram VII of assemblies of the present disclosure;

FIG. 9 is a schematic diagram VIII of assemblies of the present disclosure;

FIG. 10 is a schematic diagram IX of assemblies of the present disclosure;

FIG. 11 is a schematic folding diagram of assembling a product of the present disclosure to a foldable phone;

FIG. 12 is schematic diagram of a usage state of a product of the present disclosure; and

FIG. 13 is a schematic unfolding diagram of assembling a product of the present disclosure to a foldable phone.

### DETAILED DESCRIPTION OF THE EMBODIMENTS

In order to make the foregoing objectives, features and advantages of the present disclosure more obvious and understandable, the technical solutions in the embodiments of the present disclosure are described clearly and completely below with reference to the accompanying drawings. It should be understood that the specific embodiments described here are merely to explain the utility model and not intended to limit the utility model. In addition, it should further be noted that for the purpose of facilitating the description, part not all of structures related to the utility model are illustrated only in the accompanying drawings. Based on the embodiments in the present disclosure, all other embodiments obtained by those of ordinary skill in the art without creative work shall fall within the protection scope of the present disclosure.

Terms such as “one end”, “the other end”, “side”, “rear”, and “top” adopted in the present disclosure are used to distinguish different objects, but not intended to describe specific orders. In addition, the terms “include”, “has” and any of their variations mean covering and non-exclusive inclusion. For example, a series of connection relationships are included. Persons skilled in the art can achieve the connection effect by various technical means, which fall within the protection scope of the present disclosure.

In the description of the implementations of the present disclosure, it should be also noted that unless otherwise explicitly specified and defined, the terms “arranged” and “connected” shall be understood broadly, and may be, for example, fixedly connected, or removably connected, or integrally connected, or mechanically connected, or directly connected, or indirectly connected through an intermediate medium, or interconnection between two elements. Those of ordinary skill in the art can understand the specific meanings of the above terms in the present disclosure according to specific situations.

The “embodiment” mentioned herein means that specific features, structures or characteristics described in combination with the embodiments may be included in at least one embodiment of the present disclosure. This phrase appearing at each position in the description does not refer to the same embodiment, and is not an independent or candidate embodiment mutually exclusive with other embodiments. Those skilled in the art can explicitly and implicitly understand that the embodiments described herein may be combined with other embodiments.

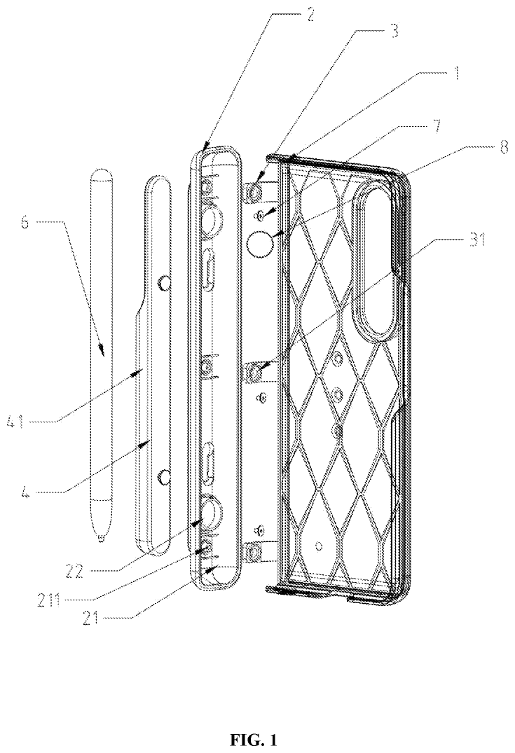

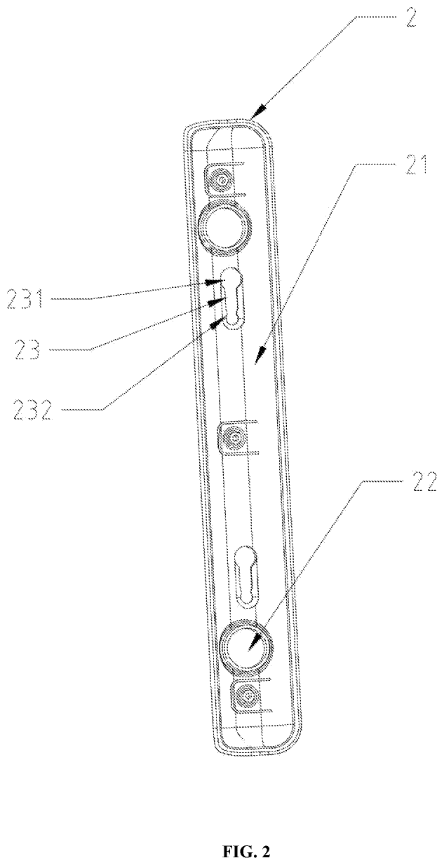

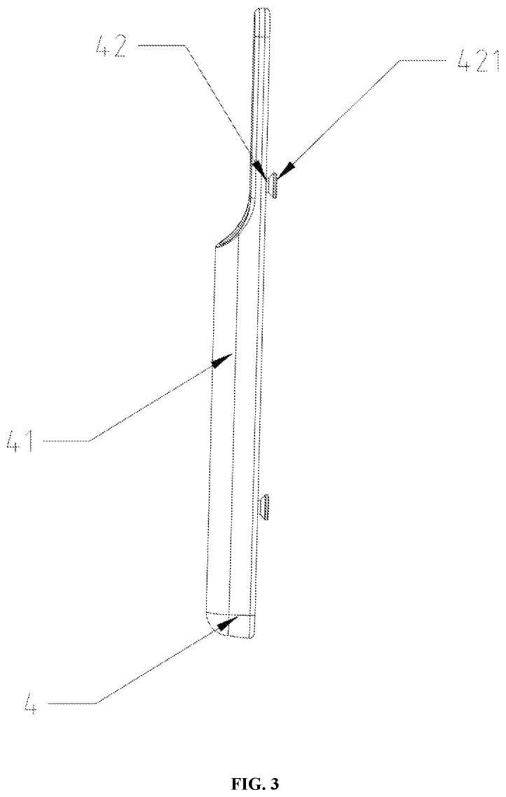

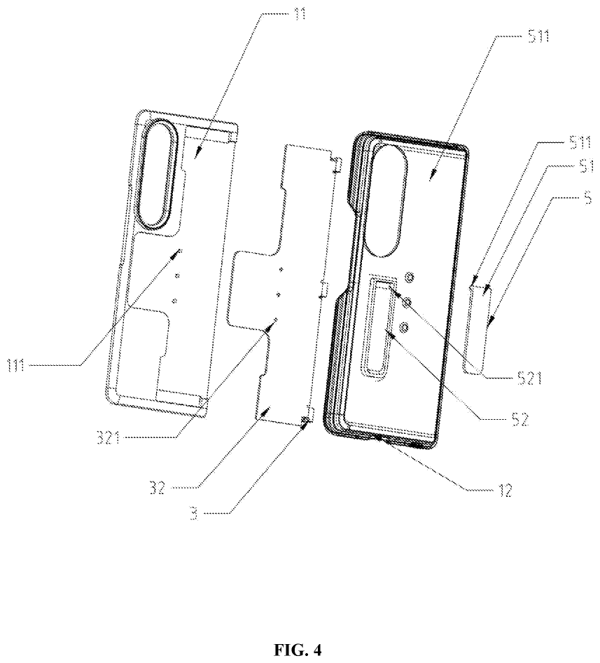

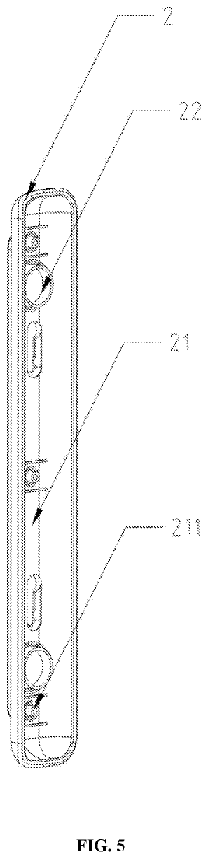

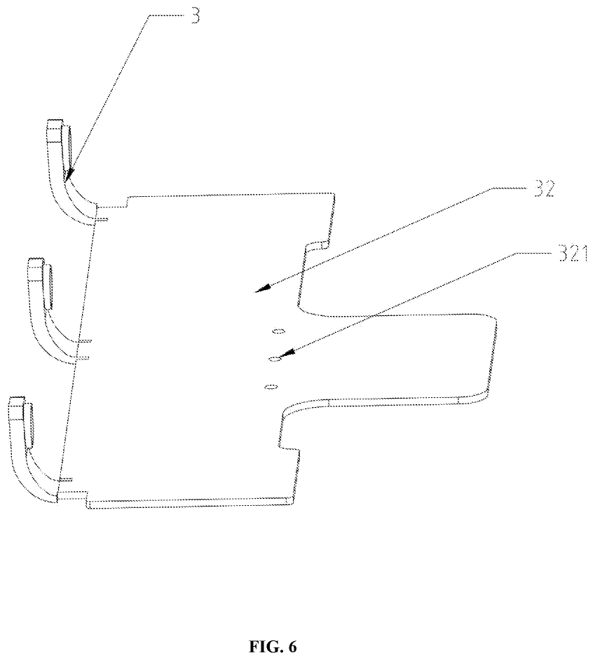

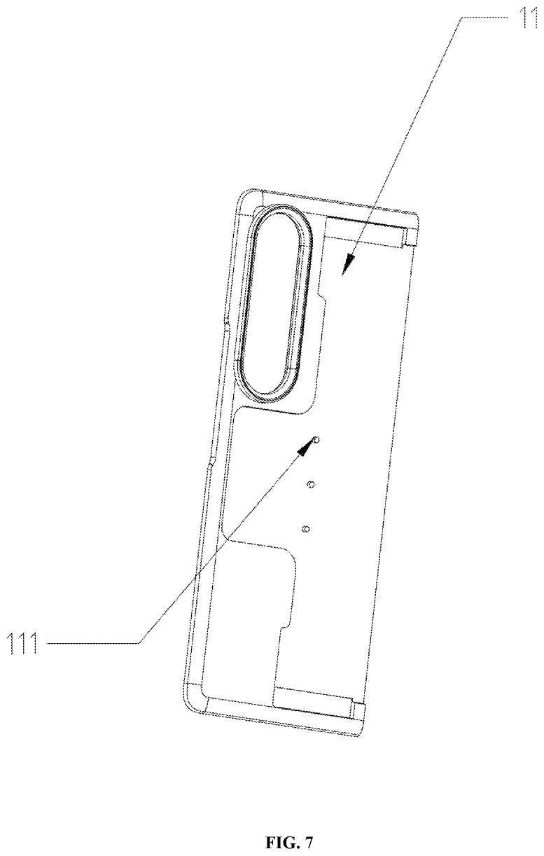

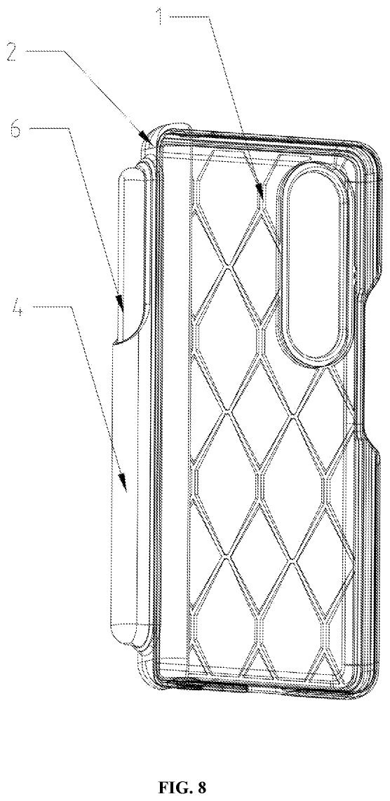

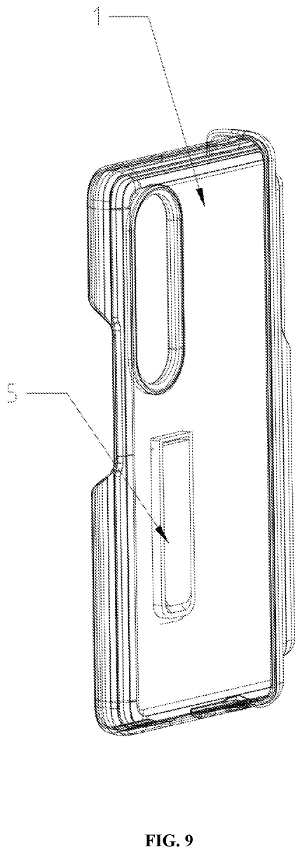

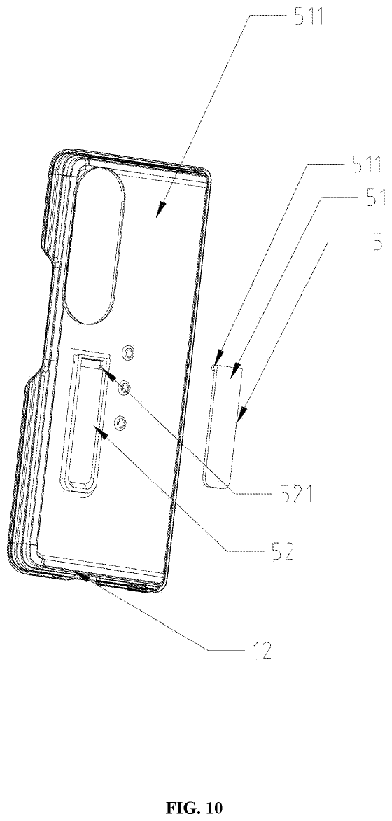

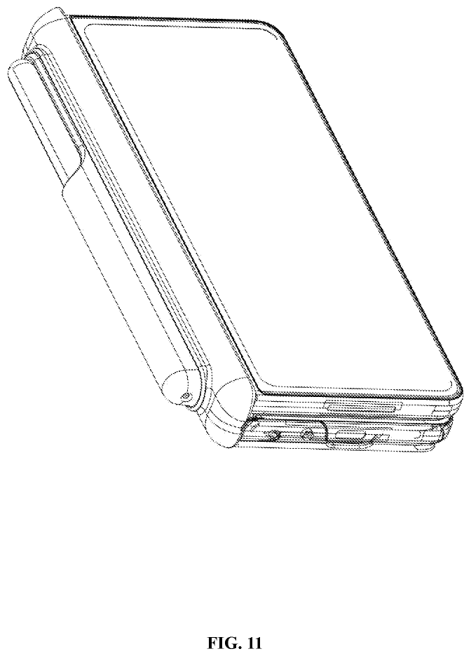

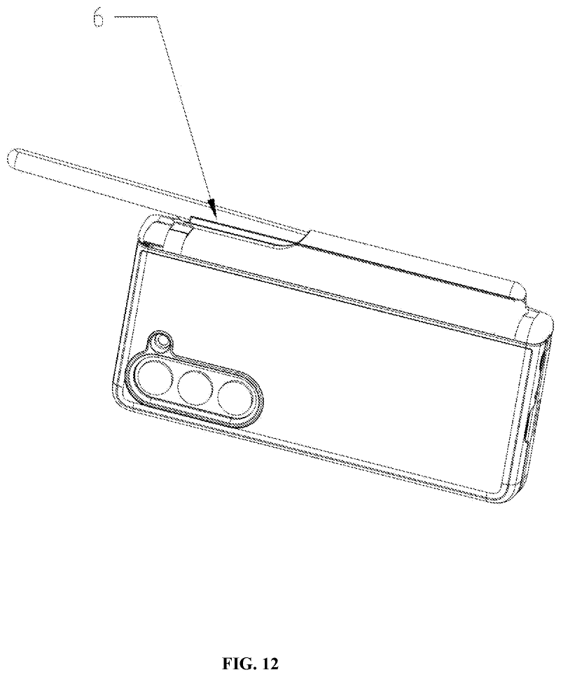

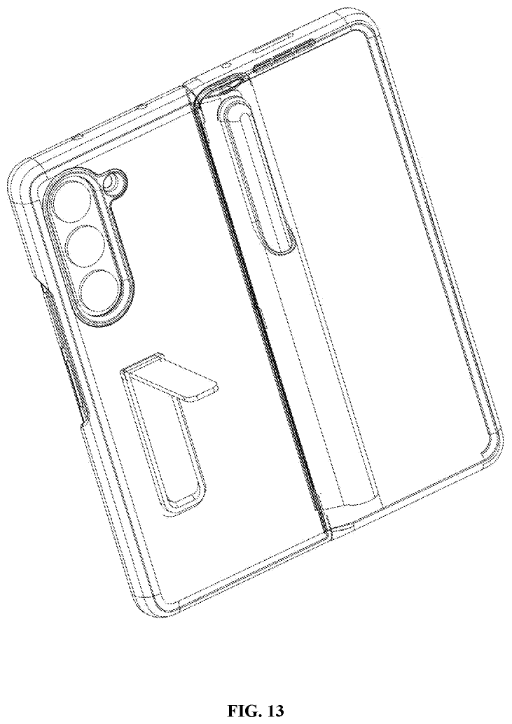

As shown in FIG. 1 to FIG. 13, the present disclosure provides a mobile phone protection case, including a case body 1. A fixed portion 2 is arranged at one end of the case body 1. The fixed portion 2 is provided with an accommodating slot 21 matched with an edge of a mobile phone. The fixed portion 2 is connected to the case body 1 through an elastic arm 3. One end of the elastic arm 3 is fixed on the case body 1, and the other end is fixed on the fixed portion 2. The elastic arm 3 is in an arc design and abuts against the fixed portion 2. A fixing slot 22 is formed in the accommodating slot 21. A magnetic element 8 is arranged in the fixing slot 22. During use (as shown in FIG. 1), the mobile phone is wrapped by the edge of the case body 1 itself and the fixed portion 2. The magnetic element 8 in the fixing slot 22 attracts the edge of the mobile phone, so that the mobile phone is stably fixed inside the mobile phone case. In a detaching process, the fixed portion 2 is pushed, and the elastic arm 3 is stressed to drive the fixed portion 2 to move, which facilitates removing the mobile phone. The elastic arm 3 returns to an initial position under the action of a restoring force. Due to the arc design, the elastic arm 3 abuts against the fixed portion 2, so that the influence of the connection between the elastic arm 3 and the fixed portion 2 on the fixing of the mobile phone (or instable connection of the mobile phone caused by a hollow portion generated in fixing) is avoided. The magnetic element 8 can be fixed in the fixing slot 22 by an adhesive or other adhesive materials. Meanwhile, the mobile phone case is applicable to a foldable phone (for example, FIG. 11 and FIG. 13). The foldable phone is fixed on the case body 1 after being folded. A fold of the foldable phone is arranged in the accommodating slot 22 of the fixed portion 2. During use, the foldable phone is unfolded, and the fixed portion 2 is stressed. The elastic arm 3 deforms to drive the fixed portion 2 to move, without affecting the fixing of the foldable phone by the mobile phone case. In order to prevent the phenomenon that the foldable phone is easily separated from the mobile phone case after being unfolded, an adhesion position is arranged on the case body 1, so that the foldable phone is fixed in an adhesion manner.

Based on the above embodiment, the present disclosure further provides a connection structure capable of fixing a stylus 6. Specifically, a pen case 4 is arranged on the other side, corresponding to the accommodating slot 21, of the fixed portion 2. The pen case 4 is provided with a stylus accommodating portion 41. The accommodating portion 41 accommodates the stylus 6. For different users, the pen case is detachably fixed on the fixed portion 2. Due to the detachable arrangement, a user can select whether to carry the stylus 6. The present disclosure further provides a detachable structure, Specifically, the fixed portion 2 is provided with a sliding clamping slot 23. The sliding clamping slot 23 includes an inlet slot 231 and a clamping slot 232. The pen case is provided with an accommodating cavity for the stylus 6. The pen case 4 is provided with a sliding column 42. One end of the sliding column 42 is a flange 421. The flange 421 enters the sliding clamping slot 23 through the inlet slot 231, and is fixed in the clamping slot 232 after moving. During detaching, the flange 421 is moved to the inlet slot 231, and is then separated from the inlet slot 231, which achieves separation of the pen case 4 from the fixed portion 2. The above stylus 6 is arranged in the accommodating cavity of the pen case 4 in a plugging manner.

In order to add functions of the mobile phone protection case, the mobile phone protection case of the present disclosure is further added with a function of a mobile phone holder. Specifically, a holder device 5 is arranged on a rear side of the case body 1. The holder device 5 includes a holder accommodating slot 52 and a holder body 51. A rotating hole 511 is formed in a top side surface of the holder body 51. A rotating column 521 corresponding to the rotating hole 511 is arranged in the holder accommodating slot 52. The rotating column 521 extends into the rotating hole 511. The rotating column 521 and the rotating hole 511 rotate relatively, which can achieve that the holder body 51 is separated from or enters the holder accommodating slot 52, so that the holder body 51 is spread and stored.

In order to better fix the elastic arm 3 to the fixed portion 2, a fixing hole 31 is formed in the elastic arm 3. A threaded hole 211 is formed in the accommodating slot 21. A stud 7 is fixed with the threaded hole 211 through the fixing hole 31. The fixing is more stable by using the stud 7.

The elastic arm 3 in this embodiment can be made of a material with a restoring force. The present disclosure provides a material and a connection structure. Specifically, the elastic arm 3 is made of a TPU material. The case body 1 includes a bottom case 11 and an outer case body 12. A fixed end of the elastic arm 3 to the fixed portion 2 is provided with a patch portion 32. The patch portion 32 is arranged between the bottom case 11 and the outer case body 12 and is bonded by a hot melt adhesive technology. In the above manner, connection between the elastic arm 3 and the case body 1 is better achieved. In order to better complete the bonding process, the patch portion 32 is provided with a positioning hole 321. A positioning column 111 is arranged on the bottom case 11. The positioning column 111 is arranged in the positioning hole 321. By means of limitation, it is more convenient to complete the process. There are three groups of the elastic arms 3. Due to the three groups of elastic arms in the present disclosure, an elastic effect and a restoring effect are better achieved. There are two groups of the fixing slots 22 and magnetic elements 8. Due to the two groups of fixing slots and magnetic elements, stable attraction of the mobile phone can be achieved.

In view of the technical problems in the embodiments, a new fixing structure for a mobile phone case and a mobile phone is provided. A fixing effect is achieved jointly by one end of the case body and the magnetic element. Due to the design of the elastic arm, the mobile phone can be fixed through the elasticity. Under a force, the fixed portion can be driven to move, which facilitates removing the mobile phone case from the mobile phone. A group of detachable pen case connection structure and mobile phone holder structure is further added, which is easy to mount and remove. At the same time, the mobile phone protection case can be applied to a foldable phone.

In summary, the various technical solutions in the embodiments can be combined with each other, and other combinations that are not disclosed in this specification shall also fall within the protection scope of the present disclosure.

What is claimed is:

1. A mobile phone protection case, comprising a case body, wherein a fixed portion is arranged at one end of the case body; the fixed portion is provided with an accommodating slot matched with an edge of a mobile phone; the fixed portion is connected to the case body through an elastic arm; one end of the elastic arm is fixed on the case body, and the other end is fixed on the fixed portion; the elastic arm is in an arc design and abuts against the fixed portion; a fixing slot is formed in the accommodating slot; and a magnetic element is arranged in the fixing slot.

2. The mobile phone protection case according to claim 1, wherein a pen case is arranged on the other side, corresponding to the accommodating slot, of the fixed portion; and the pen case is provided with a stylus accommodating portion.

3. The mobile phone protection case according to claim 2, wherein the pen case is detachably fixed on the fixed portion.

4. The mobile phone protection case according to claim 3, wherein the fixed portion is provided with a sliding clamping slot; the sliding clamping slot comprises an inlet slot and a clamping slot; the pen case is provided with a sliding column; one end of the sliding column is a flange; and the flange enters the sliding clamping slot through the inlet slot, and is fixed in the clamping slot after moving.

5. The mobile phone protection case according to claim 1, wherein a holder device is arranged on a rear side of the case body; the holder device comprises a holder accommodating slot and a holder body; a rotating hole is formed in a top side surface of the holder body; a rotating column corresponding to the rotating hole is arranged in the holder accommodating slot; and the rotating column extends into the rotating hole.

6. The mobile phone protection case according to claim 1, wherein a fixing hole is formed in the elastic arm; a threaded hole is formed in the accommodating slot; and a stud is fixed with the threaded hole through the fixing hole.

7. The mobile phone protection case according to claim 1, wherein the elastic arm is made of a TPU material; the case body comprises a bottom case and an outer case body; a fixed end of the elastic arm to the fixed portion are provided with a patch portion; and the patch portion is arranged between the bottom case and the outer case body and is bonded by a hot melt adhesive technology.

8. The mobile phone protection case according to claim 1, wherein the patch portion is provided with a positioning hole; a positioning column is arranged on the bottom case; and the positioning column is arranged in the positioning hole.

9. The mobile phone protection case according to claim 1, wherein there are three groups of the elastic arms.

10. The mobile phone protection case according to claim 1, wherein there are two groups of the fixing slots and magnetic elements.
